(19) United States
(12) Patent Application Publication
(10) Pub. No.: US 2003/0208412 A1
(43) Pub. Date: Nov. 6, 2003

(54) Method and system facilitating transactions between consumers and service providers

(76) Inventors: Willam E. Hillestad, Spicewood, TX (US); Charles F Hills JR., Austin, TX (US); Richard J Ritzema, Austin, TX (US); Daniel P Shields, Newbury, CA (US)

Correspondence Address: Howrey Simon Arnold & White, 750 Bering Drive, Houston, TX, 77057-2198, US

(21) Appl. No.: 10/344,085

(22) PCT Filed: Sep. 28, 2001
(86) PCT No.: PCT/US01/30435

(51) Int. Cl. G06F 17/60

(52) U.S. Cl. 705/26

(57) ABSTRACT

A computerized system is disclosed for facilitating the transactions between a buyer of credit (Member) with a seller of credit (Lender) (see FIG. 1). The method and system builds a credit marketplace web site that allows Members and Lenders (14) to interact in a secure and neutral environment. Members receive credit reports and may use these reports to extend anonymous credit requests. Lenders may filter the credit requests using criteria by which they will determine which offers are suitable for potential review. The extension of a credit offer by a lender to the Member causes the Lender to be charged a transaction fee, which may be shared by other Lenders who likewise extend credit offers to the member.

### CROSS REFERENCE TO RELATED APPLICATIONS

This application claims the benefit of the Provisional Application No. 60/239,184 filed Oct. 9, 2000.

### FIELD OF THE INVENTION

This invention relates generally to a computerized system for a membership of consumers to anonymously request credit and other goods or services from service providers.

### BACKGROUND OF INVENTION

Referring to FIG. 1, relationships between a consumer 10, Lenders 12, 14 and credit reporting agencies 16 are illustrated as evidenced in the prior art. Excessive interest expenses are a huge financial problem facing consumers. For example, over his lifetime, a typical consumer may spend up to half of their post-tax income on interest payments. Of course, the credit lending industry is profit-driven to maximize such interest payments. Accordingly, it is in the consumer 10's interest to seek credit on the best terms possible and to carefully shop for such credit.

Unfortunately, consumers 10 must often spend a considerable amount of time locating an appropriate Lender 12 or 14. To do so, consumers 10 may use publications, directories, recommendations, and other conventional means to locate the appropriate Lender(s) 12, 14. Lenders 12, 14 likewise advertise through various media or use direct sales methods to make known to potential consumers 10 what they have to offer.

Once the consumer 10 identifies the Lenders 12, 14 to whom they wish to extend a request for credit, the consumer 10 must separately contact each Lender 12, 14 to obtain quotes or loan information. Thereafter, Lenders 12, 14 typically interact with credit reporting agencies 16 to obtain the consumer's credit history, requesting in multiple inquiries being made concerning the creditworthiness of the consumer. Unfortunately for the consumer, these multiple inquiries can be detrimental to the consumer's credit history and actually reduce their credit rating.

Given the difficulties in finding credit and lower interest rates, the Internet or “world wide web” has provided consumers a number of new opportunities to locate Lenders to obtain a quote or a loan. For example, a number of on-line credit shopping services or loan shopping services currently exist on-line. These services send consumer loan inquiries to a limited subset of Lenders with whom the service is affiliated. To generate revenue for the service, a “margin” is typically added to every inquiry and/or completed transaction, which may be paid for by either the consumer or the service provider.

Also existing in the prior art is the concept of the “reverse auction.” In a reverse auction, providers of goods or services make offers or bids for a consumer's business. In this scheme, the entity hosting the auction earns revenues, for example, by charging the service providers a fee or percentage for every consummated transaction. The auction host thus has an incentive to ensure that transactions are consummated in order to generate revenues, which may limit the types or quality of credit requests that it will handle from consumers, skewing the auction in a way not favorable to the consumer. Additionally, the host may only affiliate with a i5 select group of service providers or lenders, thus limiting consumer options. Moreover, if a particular service provider sponsors the auction host, the auction may instead amount to nothing more than a marketing tool for the service providers, again biasing the auction process again free consumer choice.

In other words, traditional means of shopping for and purchasing credit on-line are generally not optimal for the consumers. Consumers are met with high fees, limited competition, and techniques that are generally not optimized in ways to benefit the consumer. Additionally, traditional techniques make it difficult for consumers to conveniently locate large numbers of service providers, and on-line shopping may inadvertently be harmful to the consumer's credit rating. The disclosed system addresses these shortcomings of the prior art and provides other consumer-friendly solutions to the problem of shopping for and purchasing credit on line.

### SUMMARY OF THE INVENTION

A computerized system is disclosed for facilitating the transactions between a buyer of credit (Member) with a seller of credit (Lender). The method and system builds a credit marketplace web site that allows Members and Lenders to interact in a secure and neutral environment. Members receive credit reports and may use these reports to extend anonymous credit requests. Lenders may filter the credit requests using criteria by which they will determine which requests are suitable for potential review. The extension of a credit offer by the Lender to the Member causes the Lender to be charged a transaction fee, which may be shared by other Lenders who likewise extend credit offers to the Member.

### BRIEF DESCRIPTION OF THE DRAWINGS

The foregoing and other aspects of the present invention will be best understood with reference to a detailed description of specific embodiments of the invention, which follows, when read in conjunction with the accompanying drawings, in which:

FIG. 1 illustrates a relation between a consumer, Lenders and credit reporting agencies as evidenced in the prior art.

FIG. 2 illustrates a relation between a consumer, Lenders and credit reporting agencies according to the disclosed system.

FIG. 3 illustrates a block diagram showing some of the functionality of the disclosed system.

FIG. 4 illustrates a block diagram showing some of the major components of the disclosed system.

FIG. 5 illustrates a block diagram showing further details of some of the major components of the disclosed system.

FIG. 6 illustrates a diagram of options available to a Member interacting with the computerized system of the present invention via the Internet.

FIG. 7 illustrates a diagram of options available to a Lender interacting with the computerized system of the present invention via the Internet.

FIG. 8 illustrates tables mapping process groups with options for programming the disclosed system.

FIG. 9A illustrates tables mapping data groups with options for programming the disclosed system.

FIG. 9B illustrates examples of data tables for the relational database management system used in the disclosed system.

FIG. 10 illustrates a supporting system map for programming the disclosed system.

FIG. 11 illustrates an embodiment of a map of a Member site according to the disclosed system.

FIG. 12 illustrates an embodiment of a map of a Lender site according to the disclosed system.

FIG. 13 illustrates an exemplary web page for creating a filter according to the present invention.

FIGS. 14 and 15 illustrate exemplary interfaces for Members and Lenders illustrating several different functional aspects of the system.

FIGS. 16A-B illustrate exemplary web pages for viewing filter matches and a detailed request for credit according to the present invention.

FIGS. 17A-B illustrate exemplary web pages for a Member to review offers or quotes extended from Lenders according to the present invention.

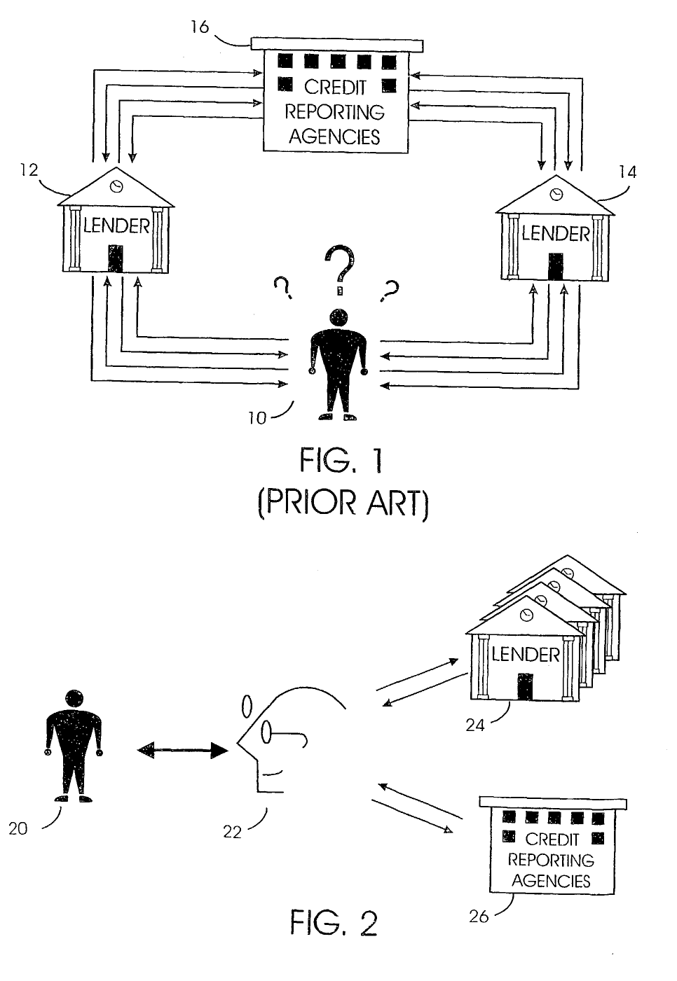

While the invention is susceptible to various modifications and alternative forms, Is specific embodiments have been shown by way of example in the drawings and will be described in detail herein. However, it should be understood that the invention is not intended to be limited to the particular forms disclosed. Rather, the invention is to cover all modification, equivalents and alternatives falling within the scope of the invention as defined by the appended claims.

### DETAILED DESCRIPTION OF THE INVENTION

I. Overview

The disclosed system provides a computerized system for facilitating transactions between two parties, such as a consumer and a service provider, in a manner optimized to favor the consumer. In general, the system uses a computer-based communications network to process a request for goods or services made by consumers and anonymously relates these requests to a network of service providers. In a preferred embodiment, the system facilitates transactions between a buyer of credit (Member) and a seller of credit (Lender). For example, the disclosed system facilitates the on-line buying and selling of auto loans, mortgage loans, installment loans, small business loans, student loans or credit cards, although one skilled in the art will recognize that the system could also be used to commercialize other goods or services.

II. General Description of the Consumer Advocacy System

Referring to FIG. 2, a relationship between a consumer 20, Lenders 24 and credit reporting agencies 26 is illustrated in accordance with the disclosed system. The system includes is a consumer advocate system 22 that interacts with the consumer 20, Lenders 24 and credit reporting agencies 26. The consumer advocate system 22 facilitates the consumer 20 in obtaining credit information from the credit reporting agencies 26 and allows for anonymously shopping for and obtaining credit or loans from the Lenders 24. As will be explained in more detail, the system 22 allows the consumer to put together an offer for credit, and in an automated fashion send an anonymous version of that offer complete with consumer credit information to Lenders for their review and potential acceptance.

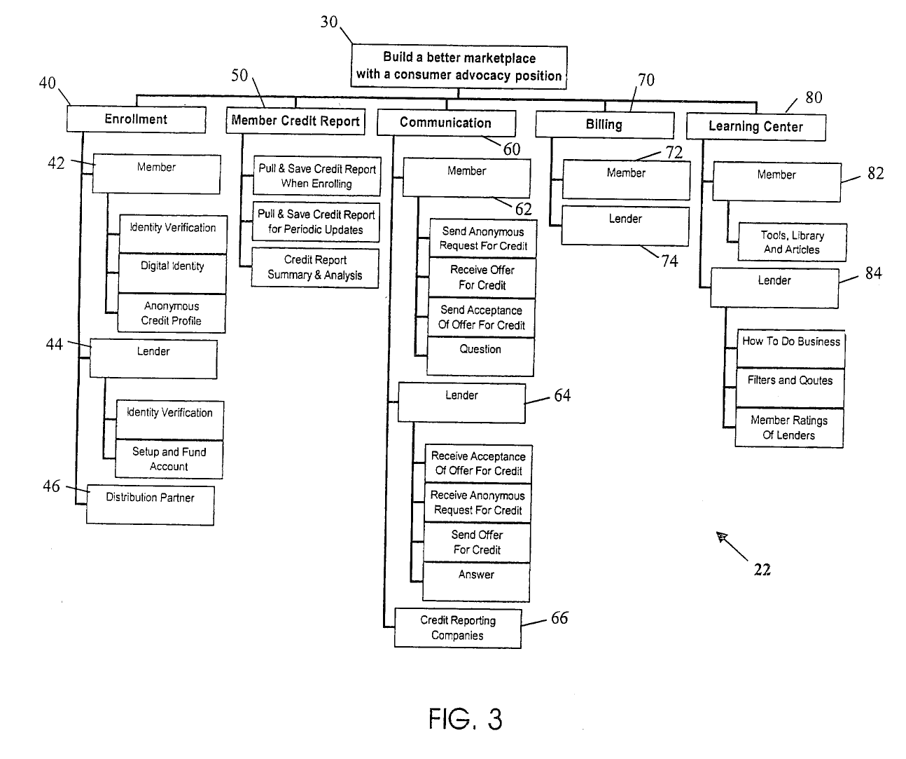

FIG. 3 presents a block diagram that illustrates in a general form the basic components and functionality of the consumer advocacy system 22. As a first step in utilization of the system, consumers and service providers must enroll in the system (block 40) to become, respectively, Members and Lenders on the system. To enroll as a Member (block 42), the consumer's identity is verified, and a digital identity or account including the consumer' credit report is established for the Member. Ultimately the system creates an anonymous credit profile for the Member that will be sent to the Lender. To enroll as a Lender (block 44), the Lender too must have its identity verified, and an account for handling fees is established as described below. System 22 may also be used to develop partnerships with companies or organizations having existing constituents, customers, clients and memberships. These companies or organizations may enroll as Distribution Partners (block 46) with system 22. Distribution Partners may constitute for example realtors, real estate companies, insurance agents, shopping clubs, non-profit organizations, unions, alumni associations and employee organizations.

As noted earlier, the system 22 obtains a credit report for each Member (block 50) from any number of preexisting credit companies, all of whom contain means for electronically procuring the same. The credit report is pulled initially upon enrollment by the Member and is stored as part of the Member's digital identity. Credit reports may also be obtained by the system 22 at periodic or scheduled intervals to update the information.

To facilitate transactions, the system relates requests and offers for credit between the Members and Lenders (block 60) by controlling and connecting the Members' outgoing and incoming information with the Lenders' outgoing and incoming information. Communication occurs in a secure and structured fashion to protect consumer information. The Members use the system to shop anonymously for credit or a loan (block 62). The anonymous credit requests are based on specific criteria that the Member defines, as described in more detail below. Using the network system, the Members can receive the offers for credit from the Lenders and can send acceptance of the offers to the Lenders. Furthermore, the Member can anonymously submit questions or inquiries to the Lenders. Lenders are likewise able to communicate with the Members using the network system (Block 64). Thus, the Lenders can send offers of credit to the Members based on specific criteria, as described in more detail below. To obtain credit reports associated with the Members' digital identities, the network system also records transaction statistic interfaces with credit reporting agencies or companies (Block 66).

The system also tracks billing and system revenues (Block 70). As an intermediary advocate for the Members, revenues for the system are not tied to the consummation of a transaction, making the system essentially free for the Member to use to shop for credit. As an intermediary advocate for Lenders, the Lenders are able to receive and evaluate requests from potential borrowers at no charge. Instead, system revenues are preferably generated only when an offer of credit is extended to a Member by a Lender. Preferably, this offer fee is paid by the Lender, thus creating a neutral, unbiased marketplace benefiting both consumers and credit providers. In other words, the disclosed system may be thought of as an anonymous reverse auction in which the Lenders pay a transactional fee to have their offers presented to or accepted by the potential buyers or Members. The Members may pay a flat membership fee for the right to submit to the system, and to cover the costs of retaining an electronic representation of the their creditworthiness, although such charges may not be necessary or may be assumed by the systems administrators if commercial considerations warrant.

Additionally, it is not envisioned in a preferred embodiment of the disclosed system that system revenue be generated by selling Member information to potential Lenders or other sellers of goods or services. Because not all Lenders may be able to afford such information, the best interests of the Members would not be satisfied by such an approach as it may potentially reduce the number of Lenders making credit offers, thus hampering competition.

By not charging Lenders for consumer information and by not generating revenue based on the consummation of a transaction, Members are greatly benefited and are met with a neutral, competitive on-line marketplace. Moreover, by charging only for extension of offers, the system benefits Lenders, which pay a fee expected to be generally much less expensive than were the Lenders to review credit offers and extend credit offers by traditional means.

Lastly, system 22 preferably provides a learning place (block 80) which provides useful tools to current and prospective users of the system. Additionally, the system 22 may track Internet site statistics, such as reports or information on Members, Lenders, Distribution Partners and affiliate program tracking, in accordance with a Privacy Policy and a Security Policy.

III. Network System

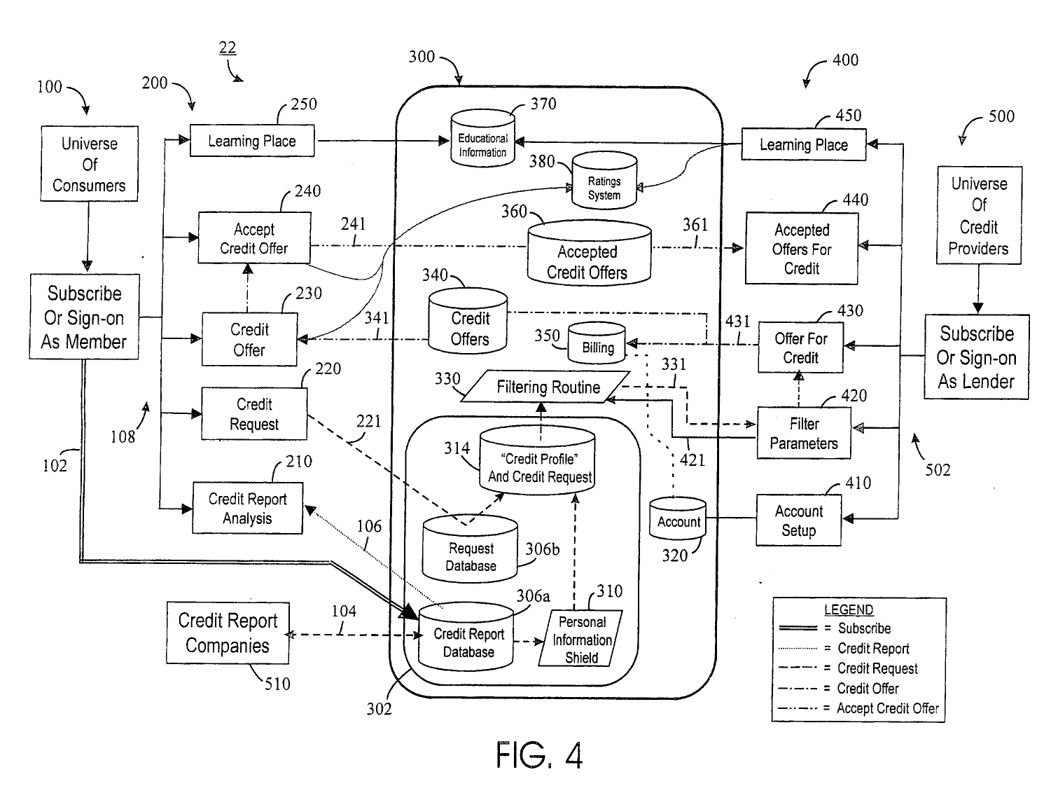

FIG. 4 discloses an embodiment of the consumer advocacy system 29, and which preferably uses the Internet as part of its implementation. Although the embodiment described herein relates specifically to the buying and selling of credit, it will be apparent to one skilled in the relevant art that the disclosed system may also be utilized to facilitate transactions involving a wide variety of other goods or services, such as revolving lines of credit, credit card accounts, home equity loans, annuities, insurance products, consumer and commercial assets, investment products and certificates of deposit. Additionally, while the Internet is preferably the communication medium used for the disclosed system, other local networks could also be used.

A. Web Site

The disclosed system preferably employs an Internet web site having HTML pages with scripting and logic components on a secured HTML World Wide Web server. The Web site includes a Member interface 200, a network system 300, and a Lender interface 400. Portions of the network system 300 are preferably secured with encryption-protection, but learning or rating areas may not be part of the “secure” portion of the network system 300. The network system 300 downloads credit inquiries, requests, membership information and credit offers, among other information, from the interfaces 200 and 400 of the web site. The network system 300 processes the information through appropriate database software and related front-end, middleware and back-end data management systems. The network system 300 of the present invention typically includes any appropriate and well-known hardware and software for hosting a website. Member and Lender interfaces 200 and 400 are accessible by personal computers or workstations as is well known in the art.

B. Member Interface

A consumer accesses the network system 300 with a personal computer via the Internet and via Member interface 200. The web site of the network system 300 has a home page, which the consumer may access using any standard Web Browser. The consumer may become a network Member 100 by completing a registration application and by providing necessary data, including their identity, which is verified using standard means. The programming (e.g. Internet HTML pages or provided software) which enables network Members 100 to interact with the network system 300 includes information sufficient for Members 100 to establish a protected Member account and make requests via the Internet.

When subscribing 102, the Member 100 enters personal information and has his identity verified. The personal information or digital identity of the Member 100 becomes part of a Member Information or Credit Report Database 306a. A credit report is then electronically obtained 104 From Credit Report Companies 510. The report is pulled at initial enrollment and at specified intervals to keep the Member's digital identity current as previously mentioned. The credit report undergoes a Personal Information Shield 310, which strips personal information about the consumer (e.g., name, social security number, etc.) The credit report is then stored as an anonymous Credit Profile in a Transactional Database 314. This anonymous Credit Profile is thus made available for sending future requests to Lenders and for personal review by the Members.

The Member interface 200 provides the Member 100 with a plurality of options including but not limited to receiving a credit report analysis 210, making a credit request 220, reviewing a credit offer 230, accepting a credit offer 240, and using a learning place 250. The member interface 200 is implemented as a plurality of web pages that allow the entry, review and transfer of data between the Member 100 and the computer network system 300.

It is important that information sent by the Members 100 to the Lenders 500 have a standardized form. To this end, menu information on the Member Interface 200 and on the Lender interface 400 is preprogrammed on the web site of the network system 300. The menus are readily upgraded to include new and revised commercially available products and services. The Members 100 use this information to prepare requests for credit that can be processed by the network system 300 and can be clearly understood by the Lenders 500. The network system 300 may populate forms with any information that has been pre-established or stored. Any particular business rules, calculations or educational content used to analyze or present data on the web site may be easily updated.

When the Member 100 selects the activity or function of making a credit request 220, the Member 100 provides any necessary information, data or criteria to effectuate the request, such as the desired type of credit (e.g., a home loan), the desired interest rate, the principal amount of the loan desired, etc. A credit request 221 is submitted to the network system 300 via the Member interface 200 of the web site. The credit request 221 is stored in a Request Database 306b and is also combined with the anonymous Credit Profile stored in the Transactional Database 314, providing an anonymous Credit Profile and Credit Request. Because the Credit Report Database 306a is hosted on behalf of the Member 100, the Member essentially owns their data. Outside entities are not allowed to view personal data of the Member 100 unless the Member allows a potential Lender 500 to receive their personal data. The credit request and credit profile in the Transactional Database 314 also includes data specific to the handling of the request as designated by the Member 100. For example, the Member 100 may explicitly permit all or only a select group of Lenders 500 to have access to their credit request and profile in the database 314.

By excluding personally identifying information from the credit request and profile 314, the Member 100 is not at risk of a third party using the personal information to their detriment. Specifically, the Member's request and profile in the Transactional Database 314 may not include the Member's name, address, social security number, account numbers, phone numbers, previous addresses or any other information which would allow a viewer to determine the identity or whereabouts of the Member 100. The most specific information given may simply be the Member's zip code or other geographical detail that a Lender might need to evaluate the transaction.

To maximize the security and anonymity of the Member 100, all personal data is stored in a secure area or domain 302 of the network system 300. Furthermore, the Credit Report and Request Databases 306a and 306b are separate from the anonymous credit profile and request in the Transactional Database 314 distributed to Lenders 500. Lenders 500 are strictly regulated in the use of Member's data that is made available to them. All personal data of the Members 100 is stored within the architecture of the network system 300 separate from the anonymous, general data or credit request and profile 314 that Lenders 500 may access when they evaluate potential customers.

As previously mentioned, the system purchases information, such as credit reports, from other data compilers about individual consumers. This compiled information is used to populate a database on the Member's behalf. The Member 100 may then use the compiled information as an anonymous, digital representation of himself or herself in the electronic marketplace of the network system 300 of the present invention. Traditionally, companies gather data on consumers to market specific goods or services to those consumers based on past behavior or statistical buying patterns. Consumers generally dislike data files being kept on their behaviors or buying patterns. However, the same data files compiled by the third parties proves very useful when the Members 100 themselves control the data. The Member 100 may make all or part of the data file available to select Lenders 500 whenever they want to request a quote for a loan or credit. The data is owned and controlled by the Member 100 and is offered to prospective Lenders 500 in a manner that prevents the Lender from receiving personal information or retaining the data for future use.

Compiling a large, relevant data file on themselves would surely prove too cumbersome a task for the Members 100. For this reason, data files of various types are purchased on the Member's behalf to populate the Credit Report Database 306a. For example, when a credit report is purchased and maintained on the Member 100, the Member may offer select information or parts of the report to Lenders 500 in order to receive bids or offers for credit. The information is given to Lenders 500 in an anonymous format. The Lenders 500 will have limited use for the information beyond responding to the Member's request. At best, this information could be used for area demographics by the Lender.

The anonymous credit request and profile 314 of the Member 100 is freely made available to the Lenders 500, unless restricted in some fashion by the Member. As a result, a credit marketplace is established in which potential borrowers anonymously post request for loans or credit along with their financial and credit information to the Internet web site of the network system 300. To generate the best possible offer for an extension of credit, any potential Lender 500 subscribing to the system may then review the credit request and profile in the Transactional Database 314, free of charge.

The format of the credit profile and request 314 allows the Lenders 500 to precisely target the Member 100 with customized offers. The fact that the Lenders 500 respond to an anonymous digital representation or credit profile of the Member 100 ensures that the Member 100 will not receive unwanted solicitations. In fact, the Member 100 is able to control when and what offers they will receive based on their interest or needs at the time. The Member 100 may thus start and stop the inflow of marketing offers at will. The Member 100 may also be able to sort their credit offers and to review only the offers that best match their needs.

C. Lender Interface

Like the Members, Lenders access the web site of the network system 300 with a personal computer via the Internet, and subscribe by completing a registration application. The Lenders provide necessary data, undergo identity verification, and establish an account 320.

Once registered, the Lender 500 then has access to a plurality of options 410-450 using the lender interface 400, including, but not limited to, setting up an account 410, filtering credit requests with parameters 420, making a credit offer 430, reviewing accepted offers for credit 440, and using the learning place 450. The lender interface 400 is implemented as a plurality of web pages that allow the entry, review and transfer of data between the Lender 500 and the computer network system 300.

The Lender 500 may filter Member credit requests by specifying certain filtering parameters 420, which the Lender 500 uses to specify decision criteria for selecting credit requests from the Members 100. For example, using the filter, the Lender may decide what types of credit offers it wished to entertain in terms of desired interest rates, principal amounts, consumer credit ratings, etc. The filter parameters 420 are submitted 421 to the network system 300, where the filters are run in a Filtering Routine 330 that searches the credit profile and credit requests in the Transactional Database 314 stored in the network system 300 matching the filter criteria specified by the Lender. The credit profiles and requests in the Transactional Database 314 matching the Lender's filter parameters or decision criteria are then made accessible 331 for the Lender 500 to review.

Upon reviewing the filtered credit request and profiles 331, the Lender 500 may act on the request by making an offer for credit 430 to the Member 100. When making an offer for credit, a credit offer or response 431 is submitted to the network system 300. The credit offer or response 431 routes to the Credit Offer Division or Database 340 of the network system 300, where the offer or response is stored for retrieval by the Member 100. In a preferred embodiment, the extension of an offer for credit may be made automatic upon the successful matching of the credit request and profile with the filter parameters, saving the Lender tine and money and generally facilitating the credit offering process.

D. Billing Structure

When the Lender 500 makes the credit offer 431, an acknowledgement is logged in a Billing Division 350 of the network system 300. The Billing Division 350 charges the Lender 500 a Secure Transmittal Fee for filing the credit offer 431. In a preferred embodiment, the Lender 500 is required to fund their account 320 prior to submitting credit offers, and the Secure Transmittal Fee is debited from the balance of the account by Billing Division 350.

As noted above, the Lender 500 pays a secure transmittal fee when electing to make a credit offer 431 to the Member 100. Because the Lender 500 is able to pre-qualify prospective borrowers before making the credit offer 431, their success rates should be higher and their “pull-through” costs for establishing a transaction with a prospective borrower will be lower, particularly when one consider traditional components of pull through costs such as data acquisition fees, telemarketing fees, and other lead-generating strategies.

In another embodiment of the fee structure, the system may be funded by all Lenders 500 who choose to extend a credit offer to the Member 100. In this embodiment, a set fee is established for extending an offer to a particular consumer. The set fee is shared by all Lenders 500 who extend a credit offer. For example, if one Lender 500 extends a credit offer to the Member 100, that sole Lender 500 will pay the entire set fee. On the other hand, if ten Lenders 500 extend credit offers based on the one credit request submitted by the Member 100, each Lender 500 will only pay 1/10 of the set fee.

E. Acceptance of Credit Offer

When the Member 100 selects to review the credit offer 230 using the Member interface 200, the Credit Offer Division or Database 340 routes the credit offer 341 to the Member 100. In a preferred embodiment, the Member 100 is not charged for access to the credit offer 341. After reviewing the credit offer, the Member 100 may elect to accept the credit offer 240 by accessing the Accept Credit Offer activity 240 on the Member interface 200. The accepted credit offer 241 is submitted to the network system 300 where it is stored in an Accepted Credit Offers Division or Database 360 for later retrieval by the Lender 500. The Lender 500, in turn, retrieves the accepted credit offer 361 from the Accepted Credit Offers Database 360 by accepted offers option 440 on the Lender interface 400.

In yet another embodiment of the fee structure, the system may be funded when the Member 100, selects an offer for credit. Upon receiving the accepted credit offer 241 from the Member 100, a specific fee is charged to the Lender 500 that extended the offer. This specific fee can replaces or supplement the secure transmittal fee as described above.

F. Embodiment of the Network System

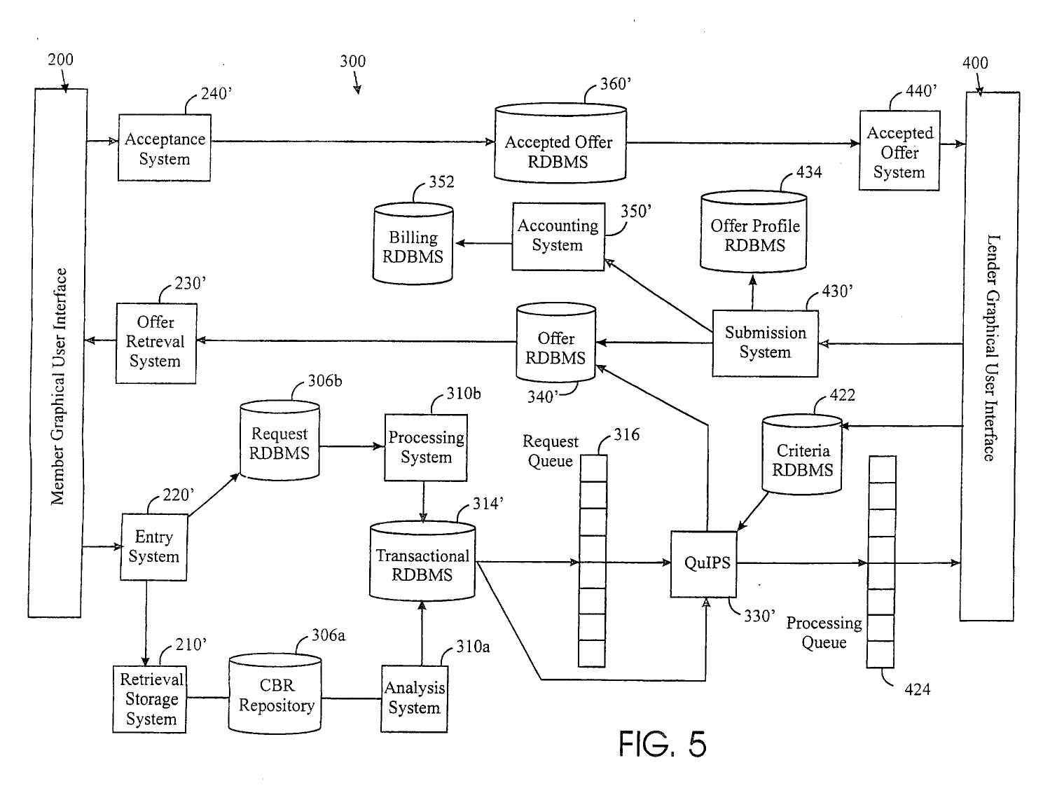

Referring to FIG. 5, a schematic diagram further illustrates subsystems and databases of the network system 300 in accordance with the present invention. The reader should note that some of the components described in FIG. 4 have been renumbered or have been expanded to show further attributes of the system 300.

The network system 300 conducts acquisition transactions using networked computers, processing software, and a storage medium. In a preferred embodiment of the present invention, the storage medium is a relational database management system (RDBMS). The RDBMS stores data in the form of related tables. The use of relational databases is preferred because the data in the tables may be extracted from the database from the Member interface 200, the Lender interface 400, and from other processing systems. An important feature of relational database management systems is that a single database can be spread across several tables, and the tables do not require any pre-designed assumptions to be made on how the data is to be interrelated.

As previously noted, the Member interacts with the network system 300 using a Member graphical user interface (GUI) 200 on a computer connected to the network system 300. The network system 300 includes a request entry subsystem 220′, having a plurality of HTML pages and includes a request RDBMS 306b where credit requests are recorded. The request includes product identification data, such as the desired type of loan, and includes the Member's city and state of residence, income, and other personal and financial information.

The network system 300 includes a request processing subsystem 310b, which creates a record for each credit request that the Member submits to the system 300. The request processing subsystem 310b records the request in a transactional RDBMS 314′ and queues the request in preparation for additional processing in a request queue 316.

Using the request entry subsystem 220′, the Member may also request a credit bureau report (CBR), although the network system 300 may request the credit bureau report automatically. The network system 300 includes a retrieval and storage subsystem 910′, having a plurality of HTML pages by which the Member's request for the credit bureau report is entered. The credit bureau report is collected from a credit-reporting agency, such as CSC/Equifax, Experian or Transunion, via computer software over a secure network connection. The credit bureau report is then recorded by the software in a CBR repository RDBMS 306a. The CBR repository RDBMS 306a is physically separated from other RDBMS's in the network system 300. The CBR repository RDBMS 306a is reserved for the storage and retrieval of personally identifying information on the Member and is accessible only through a secure channel. Lenders are not allowed to view the identifying Member information in the CBR repository RDBMS 306a until the Member accepts an offer from a Lender.

The network system 300 includes an analysis/processing subsystem 310a, which summarizes the collected CBR. The analysis/processing subsystem 310a also prompts the Member for additional inputs or verifications regarding past credit or other transactions, income levels, current interest rates on open accounts, etc. A summary of the credit report analysis is presented to the Member via a plurality of HTML pages. The analysis/processing subsystem 310a strips all identifying data (name, street address, telephone numbers, actual business and credit account numbers, etc) from the summary to form an anonymous credit profile of the Member. The anonymous credit profile is then stored in the transactional RDBMS 314′.

A Lender is able to receive the request through a query engine. The network system 300 includes a Quote Interchange Processing System (QuIPS) 330′. The Quote Interchange Processing System 330′ performs comparisons of the requests in the transactional RDBMS 314′ with criteria entered by the Lenders. The product identification data and additional information in the credit request is compared with the records in a Criteria RDBMS 422. In response to the comparison, at least one of the Lenders is identified for notification.

To obtain credit requests and Member profiles that meet their certain criteria or filters, the Lender utilizes a number of filters stored in the Criteria RDBMS 422. Accordingly, the Lender graphical user interface 400 includes a filter engine, enabling Lenders to receive any or all prospects of a specific category or within a certain parameter. For example, one Lender may prefer FICO (Fair Isaac) scores ranging from 650 to 700, while another Lender may prefer FICO scores between 600 and 650. Although a set of standard filter options for product type and credit amount may be available, each Lender may customize and save their filter criteria with the Lender GUI 400. In particular, the offers may be sorted or filtered according to geographical location, interest rate levels, length of loan, contract terms and other specific or general details.

For every filter a Lender creates, a special, temporary “inbox” or processing queue 424 is created for that filter. This inbox 424 receives requests matching the filter criteria. If the Lender has autoresponse activated for the filter, then every match automatically generates an extended quote or offer through a Submission System 430′ described below. If the filter requires a manual response, an offer or quote is not extended until explicitly done so by the Lender using GUI 400. Even so, the Lender can only review requests matching their filters, i.e., requests present in the processing queue 424.

The credit requests in the transactional RDBMS 314′ can contain drastically different types of data than the filters or criteria in the Criteria RDBMS 422. In order for the QuIPS 330′ to make comparisons and matches, it is important that a common, “supertype” be available for both the requests and the filters.

For example, the credit requests from the Members in the transactional RDBMS 314′ may be broken down into two pieces: voluntary data and involuntary data. The voluntary data is the information the Member has explicitly provided with respect to the desired loan product. For example, if the request is for a mortgage loan, voluntary data would include active military information, subject property type, occupancy, and other information the Member voluntarily submits as part of the request. The involuntary data is information provided by the credit profile from the credit report or other sources. The Member has no direct control over such involuntary data. Examples of involuntary data would include the Member's FICO score, number of late payments on trade line accounts, and bankruptcy information.

A simplified, hierarchical breakdown of a credit request stored in the transactional RDBMS 314′ may be as follows:

Request Object

Voluntary Data

Common Elements
Loan Specific Elements

Loan Type
Loan Subtype
Mortgage Fields
Automobile Fields
Credit Card Fields
Installment Fields
Personal Loan Fields

Involuntary Data

Credit Report
Any Calculated Fields
Potential Information from Other Sources

Status Elements

Active
Withdrawn
Expired

Moreover, the filters or criteria may include three components. One component is the query elements of the filter in the Criteria RDBMS 422. A second component of the filters is the request inbox 424, and a third component is a quote template used in automatically responding to the credit requests that match the filter or criteria in the Criteria RDBMS 422. If the filter is changed, a new filter/quote record is instantiated. The previous filter/quote mechanism remains active until its expiration date or until the Lender deactivates it Using filters in the Criteria RDBMS 422 separate from a quote template requires too much support and potentially causes confusion for end-users. For this reason, the filter and quote template are combined in the Criteria RDBMS 422.

A simplified, hierarchical breakdown of a filter and quote template in the Criteria RDBMS 422 may be as follows:

Filter Object

Query Elements

Common Elements
Loan Specific Elements

Loan Type
Loan Subtype
Mortgage Fields
Automobile Fields
Credit Card Fields
Installment Fields
Personal Loan Fields

Request Inbox

Pointer to Request
Request Status (in relation to this filter)

Quote

Loan Type
Loan Subtype
Mortgage Fields
Automobile Fields
Credit Card Fields
Installment Fields
Personal Loan Fields

Status Elements

New Count
Total Count
Filter Status

In a preferred embodiment of the present invention, the Quote Interchange Processing System 330′ has two components, a Quote Interchange Processing System Real Time (QuIPS-RT) and a Quote Interchange Processing System On Demand (QuIPS-OD). Each of the two components compare the credit request in the request queue 316 with the filters in the Criteria RDBMS 422, but in different manners to achieve different results. QuIPS-RT is designed to populate the inbox 424 with requests in real time. For example, the QuIPS-RT may use a continuous process or “daemon”. The daemon is a program that removes each credit request from the request queue 316 in a first in, first out (FIFO) fashion. Alternatively, QuIPS-RT may run as a short-interval “cron”, depending on system load. As matches occur, a reference or location of the credit request in the transactional RDBMS 314′ is recorded in the Lender's processing queue or inbox 422. In other words, if a filter has been defined, activated, and is running, QuIPS-RT runs in real time, placing requests into inbox 424 as they come in. The functionality of QuIPS-OD may be controlled by the Lender at GUI 400. QuIPS-RT runs continuously in the background. Therefore, the functionality of QuIPS-RT cannot be directly controlled by the Lender at GUI 400, other than what the Lender selects when creating a filter.

A basic flow process of a request/quote cycle for Quips-RT is as follows. The flow process is initiated on the Member side when the Member submits a request with the request entry subsystem 220′ and the request is stored in the transactional RDBMS 314′. The request is stored in inventory or the request queue 316. Then QuIPS-RT runs through all Lender filters in the Criteria RDBMS 422, evaluating whether the request fields match the filter fields. If a match occurs, the request is placed in the inbox 424; else the request is discarded. Running through all of the Lender filters may take a considerable amount of time. To improve performance, filters are stored in separate tables within the Criteria RDBMS 422. The tables are specific to the loan-types. Furthermore, with the filters stored in separate tables within the Criteria RDBMS 422, the columns for each filter can be fine-tuned to ease computerized searching.

The Quote Interchange Processing System-On Demand (QuIPS-OD) operates in essentially the same manner as the QuIPS-RT, although it allows the credit requests to be reviewed by the Lender before they are populated into inbox 424, i.e., it essentially acts as a search engine. Although some core logic will be shared by the QuIPS-RT and QuIPS-OD components, it is preferable that these components operate at least in part as separate programs. When QuIPS-OD functionality is chosen by the Lender, previously specified filter information (stored in RDBMS 362) or new filter criteria is selected by the Lender on the GUI 400. QuIPS-OD applies the filter to the request queue 316 to locate matching requests, which are then sent to the GUI 400 for the Lender's review. As this process may take some time, the Lender is free to browse other portions of the GUI 400 while waiting, and may return to the relevant portion of the GUI 400 to check the status of the results as QuIPS-OD runs in the background.

The Quips-RT subsystem continues to work and place records into the inbox 424 of the filter and has no real point of completion. The Quips-OD subsystem might display a flag indicating completion, but that the number of recorded matches may continue. To support new or random filter queries from the Lender GUI 400, an activation flag is used to designate whether the filter is gathering data, but more specifically, whether the filter is participating in Quips-RT. If a Lender creates a new Filter without activating it, the results of a query may still be previewed. Inactivating the filter stops the matching process and creates a “snapshot”. An active filter, by contrast, means the filter is participating in Quips-RT. Once in this realm, some filters can have autoresponse.

When a credit request is placed into the processing queue or inbox 424, only a pointer to the request actually appears in the inbox 424. The request is actually located in the transactional RDBMS 314′. The insertion of the pointer avoids redundancy in the data and makes maintenance and coding simpler. For example, withdrawing a request from the transactional RDBMS 314′ does not require removal of information from the inbox 424. The pointer to the withdrawn request remains and points to a nonexistent request in the transactional RDBMS 314′.

Accordingly, with the QuIPS subsystem 330′, the credit request is made available to the Lenders via the Lender GUI 400. Communication of the request to the Lenders includes adding a record or a pointer of the request to the Lender's inbox 424 when a match occurs as described above. Communication of the request to the Lenders may also include sending an e-mail message to an e-mail messaging service or other electronic services capable of receipt and display of such transmissions.

The Lender, if they choose to present an offer or response to the credit request, enters the Lender provided data in a Submission System 430′. The Lender offer is developed using the Lender GUI 400 and the Submission subsystem 430′. Lenders fill out standard computerized forms to submit the offer. Alternatively, the subsystem can easily be configured to allow matching requests to be immediately configured as offers, either with or without the need of the Lender accessing GUI 400. The Submission subsystem 430′ may run an analysis on the forms and their content and advise the Lenders as to how to complete and communicating the offer to the Member.

The offer is stored in an Offer RDBMS 340′, where it awaits retrieval by the Member. The offer is also profiled in an Offer RDBMS 340′ for statistical analysis and evaluation purposes. An Accounting subsystem 350′ may be activated at this point, logging a Secure Transmittal Fee to the Lender and recording the transaction in a Billing PDBMS 352, as previously described.

The Member reviews the credit offers from the Offer RDBMS 340′ using an Offer Retrieval subsystem 230′ with the Member GUI 200. The Offer Retrieval subsystem 230′ may include a filter engine for the Member to sort the credit offers they receive. The offer can be reviewed by the Member and either accepted or denied. The Member accepts the offer using an Acceptance subsystem 240′ with the Member GUI 200. The acceptance is stored in an Accepted Offer RDBMS 360′. The Lender, in turn, retrieves the acceptance using an Accepted Offer subsystem 440′ with the Lender GUI 400.

IV. Member and Lender Options

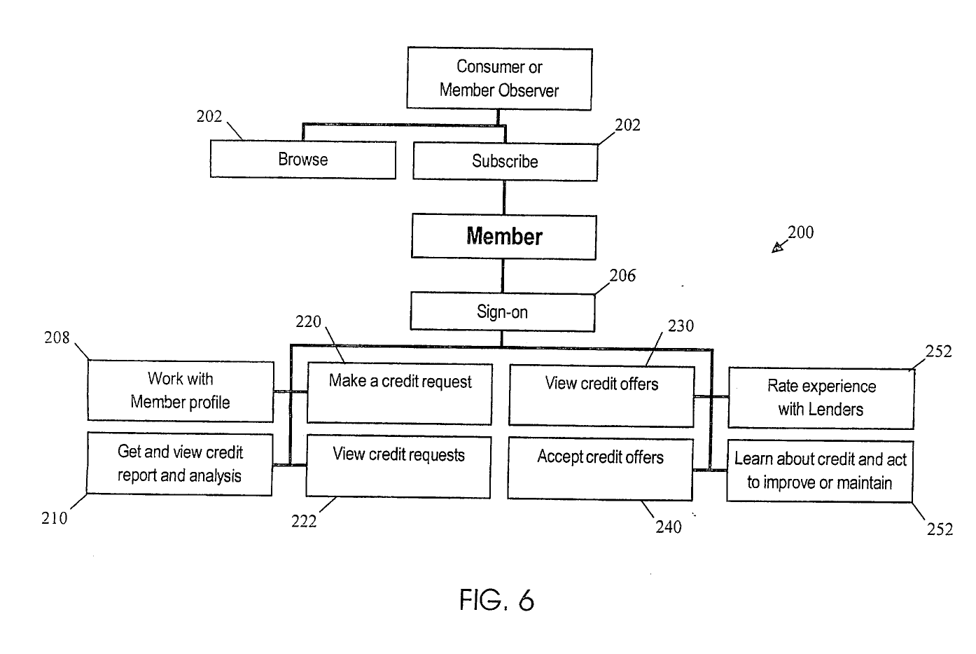

Referring to FIG. 6, a diagram illustrates the options available to consumers when interacting with the computerized system of the present invention via GUI 200. The consumer (or Member if already enrolled on the system) may browse certain aspects of the web site (block 202) to learn more about the system. If this browsing is enticing to the consumer, he may enroll as a Member (block 204) as previously described. When enrolling, the consumer preferably fills out an on-line application, accepts the terms of the system, has his identity verified, etc. A unique Member username and password are also provided. An initial credit report is then pulled, and an analysis of the report is performed. Membership or credit report fees may also be collected at the enrollment stage.

Once enrolled, the Member can sign on to the network (block 206) via the GUI 200 using his username and password. Thereafter, the Member has several options at his disposal. The Member may review or update its Member Profile and associated accounts (block 208). The Member may obtain and review their credit report and a credit analysis (block 210). The Member may also make credit requests (block 220), review the status of pending credit requests (block 222), review credit offers (block 230) made by Lenders, and accept such credit offers (block 240). The GUI 200 contains tools to allow the various request, offers, and other information presented to the Members to be organized, sorted, or filtered according to Member preferences. While reviewing responses to their credit request, Members may also communicate anonymously with the Lender making the response via the network system. As previously mentioned, Members do not need to reveal their identities until formally accepting an offer from a specific Lender. Members may also rate the Lenders (block 252). Such ratings are useful to the Members to understand which Lenders provide good services and to the Lenders to understand how they might better improve their services. Finally, Members may learn more about credit and financial information from the web site (block 254), which preferably contains information Members can use, for example, to assist them in shopping for credit or improving their credit rating.

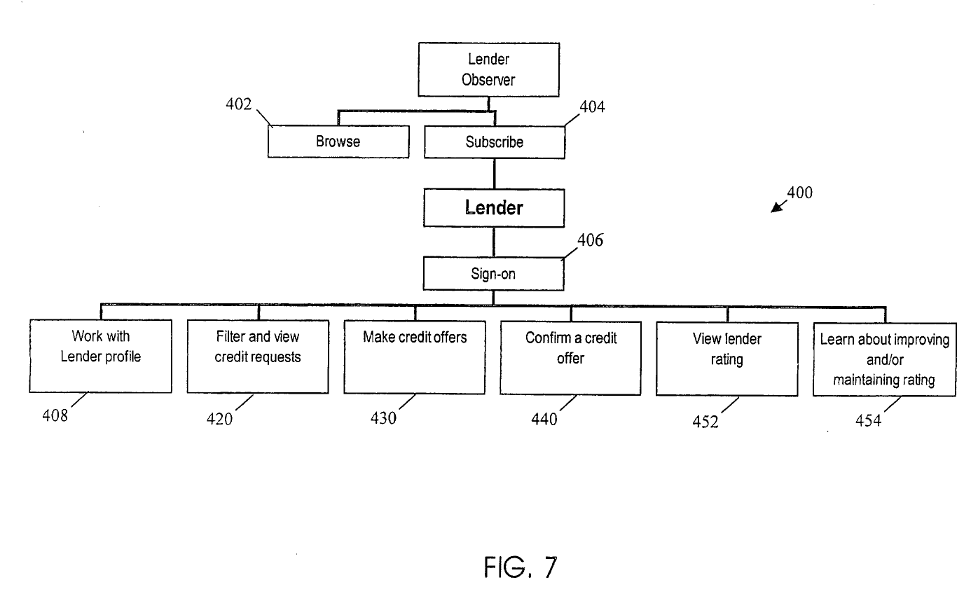

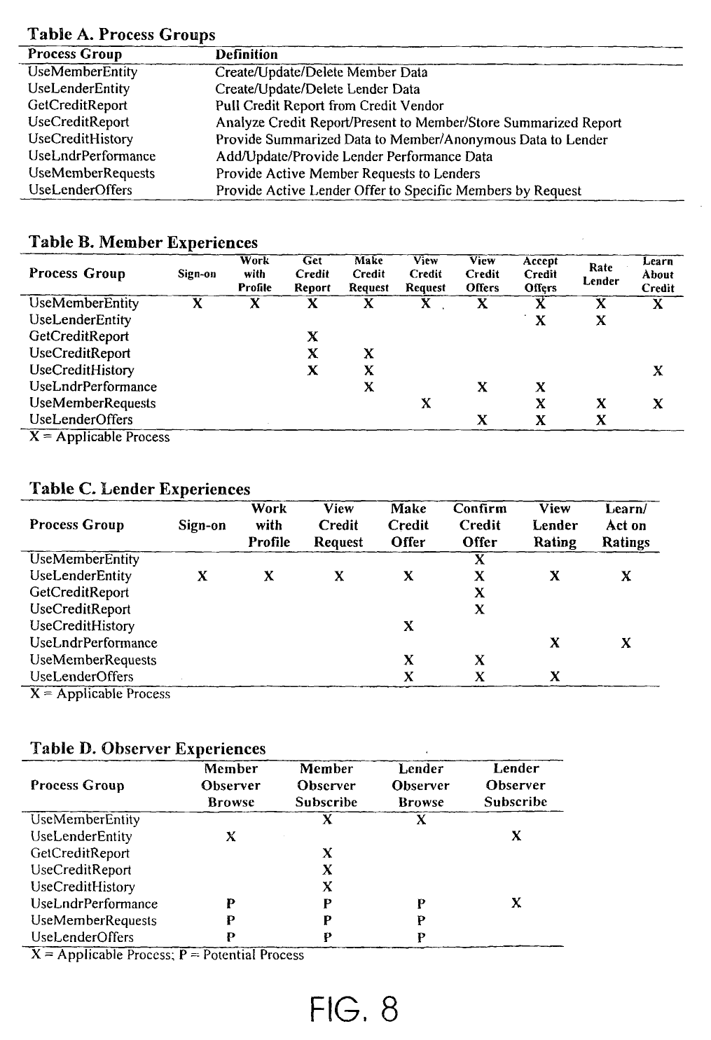

FIG. 7 is similar to FIG. 6, but illustrates options available to service providers or Lenders when interacting with the computerized system of the present invention via GUI 400. As these Lender options largely mimic the options of the consumer or Members as reflected in FIG. 6, and because these options have already been described in this disclosure, FIG. 7 is only briefly discussed. Service providers even before they are enrolled as Lenders, may review (block 402) the system and, in a preferred embodiment, may review some credit requests/offers to judge the quality and types of credit requests that are available.

VI. System Maps

To help illustrate the process and data groups required to program the system of the present invention, FIGS. 8 through 10 present tables interrelating the process and data groups with the Member and Lender options disclosed in FIGS. 6 and 7 and elsewhere in this disclosure. Referring to FIG. 8, Tables A through D map process groups with system user options. Table A lists the process groups and provides a short description of each. Table B shows which process groups are implicated for each of the Member options specified in FIG. 6. Table C shows which process groups are implicated for each of the Lender options specified in FIG. 7. Table D shows which process groups are implicated for the options presented to prospective Members and Lenders (i.e., Observers).

As one example, the process “UseCreditHistory” describes the instruction to provide summarized credit history information to a Member and to forward anonymous data to Lenders. This process correlates with the Member options “Make a Credit Request,” “Get Credit Report.” and “Learn about Credit” (see Table B). On the Lender Side, this process correlates solely with Lender option “Make Credit Offer” (see Table C). Of course, which process groups are utilized by a particular user option is a matter of the desired functionality and could be changed. In this respect, FIG. 8 provides only an exemplary map for defining the disclosed system.

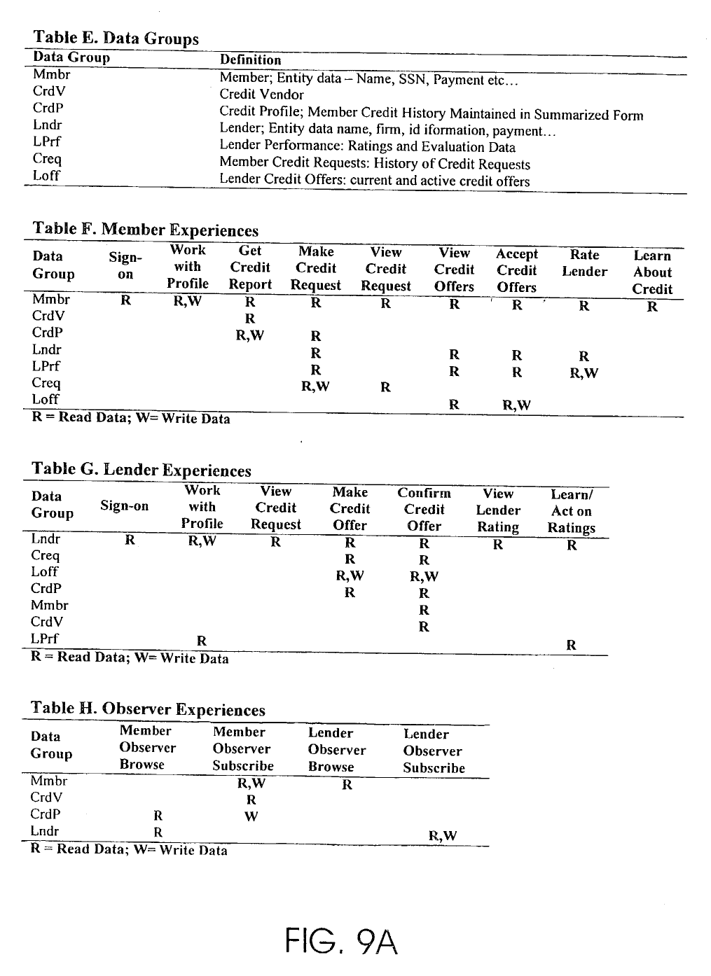

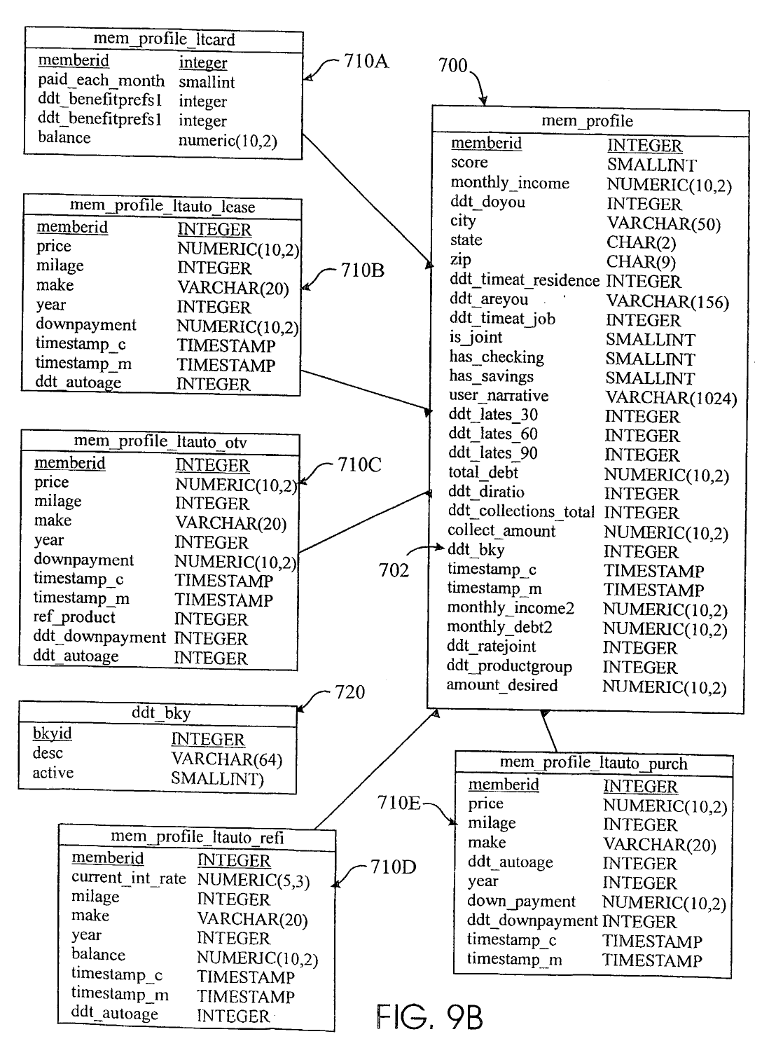

FIG. 9A is similar to FIG. 8, but maps data groups with system user options. Table E lists the data groups and provides a short description of each. Table F shows which data groups are implicated for each of the Member options. Table G shows which data groups are implicated for each of the Lender options. Table H shows which data groups are implicated for the options presented to prospective Members and Lenders (i.e., Observers). Depending on the desired functionality of the system, a particular data group can be a file, a list of files, or a list of database array files.

As one example, the data group “Mmbr” includes the entity data for the Members, such as name, social security number, residence, phone number, etc. Throughout the Member options, the “Mmbr” data group is used primarily in a readable format only (designated as “R” in FIG. 9A). However, under the option “Work with Profile”, a Member is able to write, add or select data for entry into the data group. By contrast, on the Lender's side, the “Mmbr” data group is utilized only with Lender option “Confirm Credit Offer” and there as a read-only file. As disclosed earlier, this makes sense considering that a Member's identity can only be confirmed by the Lender after the Member has accepted the credit offer.

As noted above, a preferred embodiment of the present invention uses a relational database management system. Thus, the “Mmbr” data group comprises a plurality of relational databases or tables. For example, a “mem_profile” data table shown in FIG. 9B is one example of such relational databases or table. The mem_profile data table 700 thus constitutes part of the “Mmbr” data group and may be related to other data tables, such as another table on the Member containing detailed personal information on the Member.

Mem_profile data table 700 contains Member profile data. All or part of the mem_profile data table 700 may be used in the process groups as described above in FIG. 9A. For example the mem_profile data table 700 may be used in creating a request for a quote (“Creq”). Data elements within the mem_profile data table 700 may be read and subsequently written in a data table within the “Creq” data group. In this way, the mem_profile data table 700 would be indirectly related to a data table containing information corresponding to the request.

A number of related data tables 710A-E are illustrated in FIG. 9B. The related data tables 710A-E may include, for example, data tables profiling loans owed by the Member, among other possible related tables. For example, the mem_profile_ltcard data table 710A is related to the mem_profile data table 700, and contains profile information on a credit card account owed by the Member. In addition, data elements within the data tables 700 and 710A-E may be supported by supporting tables. For example, the ddt_bky data element 702 in the mem_profile data table 700 is supported by the ddt_bky supporting table 720, which provides space for a description of a bankruptcy of the Member.

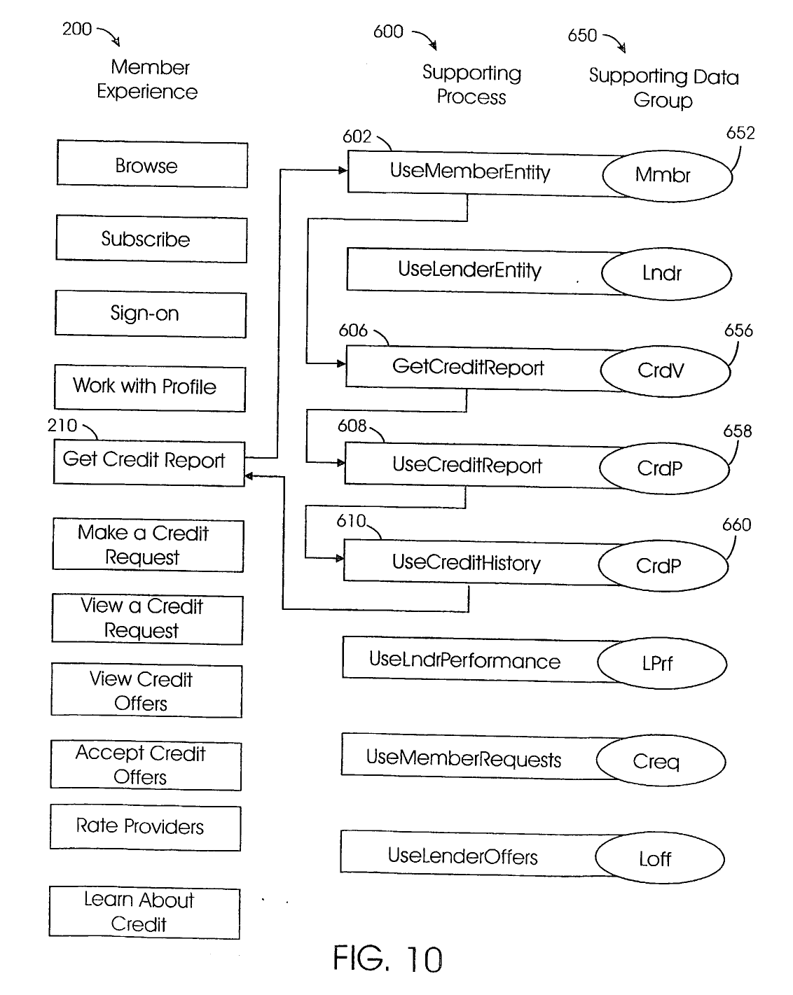

FIG. 10 shows a supporting system map which correlates the Member option of “Getting and Reviewing Credit Worthiness” 210 with the supporting process groups 600 in FIG. 8 and with the data groups 650 in FIG. 9A. It is fully understood that the present FIG. 10 illustrates only a limited example and does not constitute a complete map of the entirety of the system. A more extensive supporting system map may be readily developed by combining the information from the Tables A-H in FIGS. 8 with the information in FIGS. 9A and 9B, as one skilled in the art will immediately recognize.

FIG. 10 shows the implication of the various process groups 600 and data groups 650 when a Member wishes to review his creditworthiness 210. As an initial step, the Member accesses the appropriate option 210 on GUI 200 to start the process. Thereafter, as FIG. 10 shows, the process “UseMemberEntity” 602 is initiated, allowing the Member to create, update or delete data in the “Mmbr” data group 652. Next, the system obtains the Member's credit report by accessing the process “GetCreditReport” 606, which involves pulling the credit report from a credit vendor in the data group of credit vendors, “CrdV” 656. Next, the process “UseCreditReport” 608 is initiated, and the credit profile in the data group of “CrdP” 658 is accessed. Here, the credit report is analyzed, summarized for the Member to review, and stored for future use. Finally, the process “UseCreditHistory” 610 is initiated, wherein the Member is provided with summarized data and anonymous data appropriate for review by a Lender.

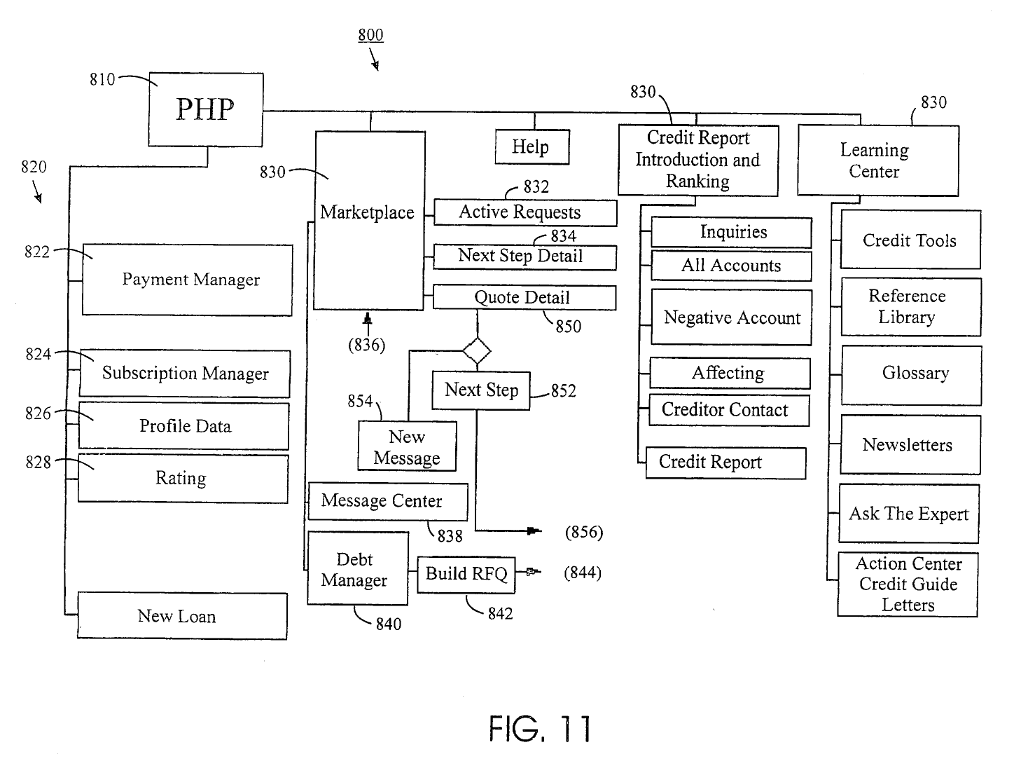

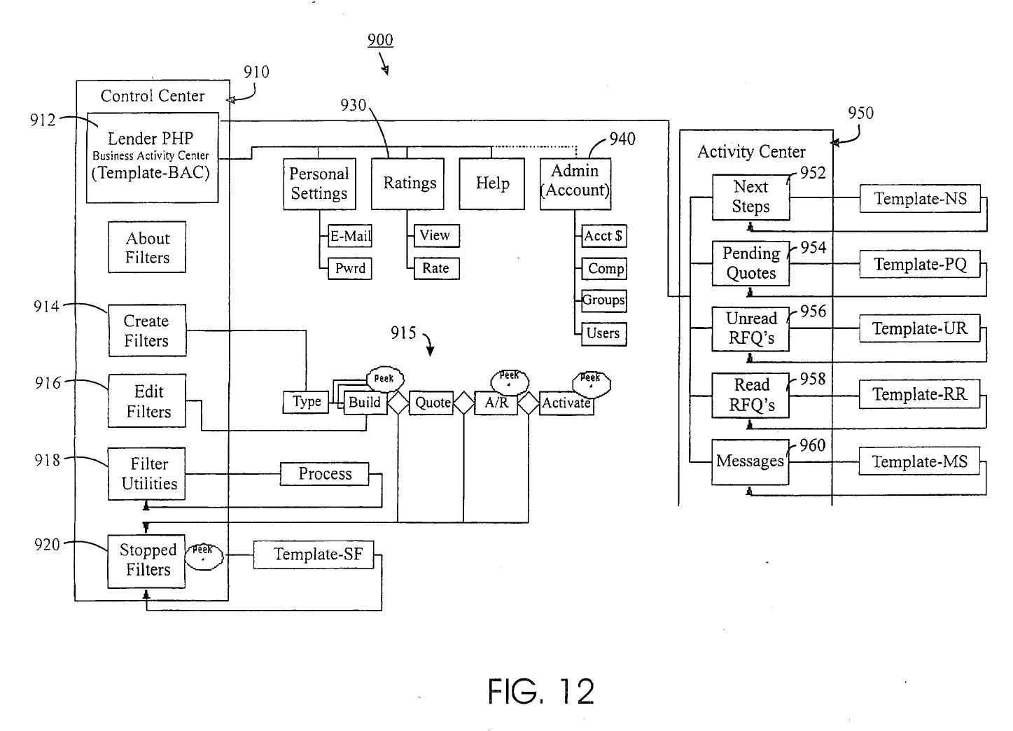

FIGS. 11 and 12 illustrate site maps for implementing the Member and Lender graphical user interfaces (GUIs) 200 and 400 on the Internet. FIG. 11 shows the Member Site Map 800 by which Members may access their personal home page (PI-IP) 810 on the web site. The personal home page 810 includes secure access to the Member's private information, a view of their detailed financial data, and a list of additional Member services available including, but not limited to Member credit rating and ranking, programs to improve credit rating, steps to correct credit errors, calculators, and informative articles from credit experts.

From their personal home page 810, the Member has access to a plurality of local navigational links 820 and a plurality of global navigational links 830, 860 and 870. Under the local navigational links 820, the Member may access a Payment Manager 822 to make changes to their account and a Subscription Manager 824 to select publications or articles they wish to review. The Member may also review and edit their Profile Data 826 or review or make Ratings 828 on the Lenders.

Under the global navigational links, the Member may access a Marketplace 830, a Credit Report Introduction and Ranking Area 860, and a Learning Place 870. The Learning Place 870 provides tools for improving credit, a reference library, a glossary and newsletters. The Learning Place 870 also allows the Member to solicit questions regarding credit and provides an action center with sample letters for repairing or improving the Member's credit. The Credit Report Introduction and Ranking Area 860 enables the Member to track its credit or loan accounts, review its credit report, or contact creditors.

The Marketplace 830 includes the links to credit requests and credit quotes. In the Marketplace 830, the Member may review active credit requests 832, review details of the next steps in completing the credit process 834, receive responses to pending quotes from Lenders 836, or review messages from Lenders in a Message Center 838.

In the Marketplace 830, the Member may also access a Debt Manager 840 where the Member may build a request for quote (RFQ) 842. The request for credit is anonymously relayed to the Lender side 844 of the Web site Map as previously described. In the Marketplace 830, the Member may obtain details about credit quotes from the Lenders. When obtaining quote details 850, the Member may anonymously pose questions 854 to the Lender by sending a message regarding the quote received from the Lender. If the Member wishes to accept the quote or offer for credit from the Lender, the Member follows through with a next step 852, which is communicated to the Lender side 856 and which is no longer anonymous.

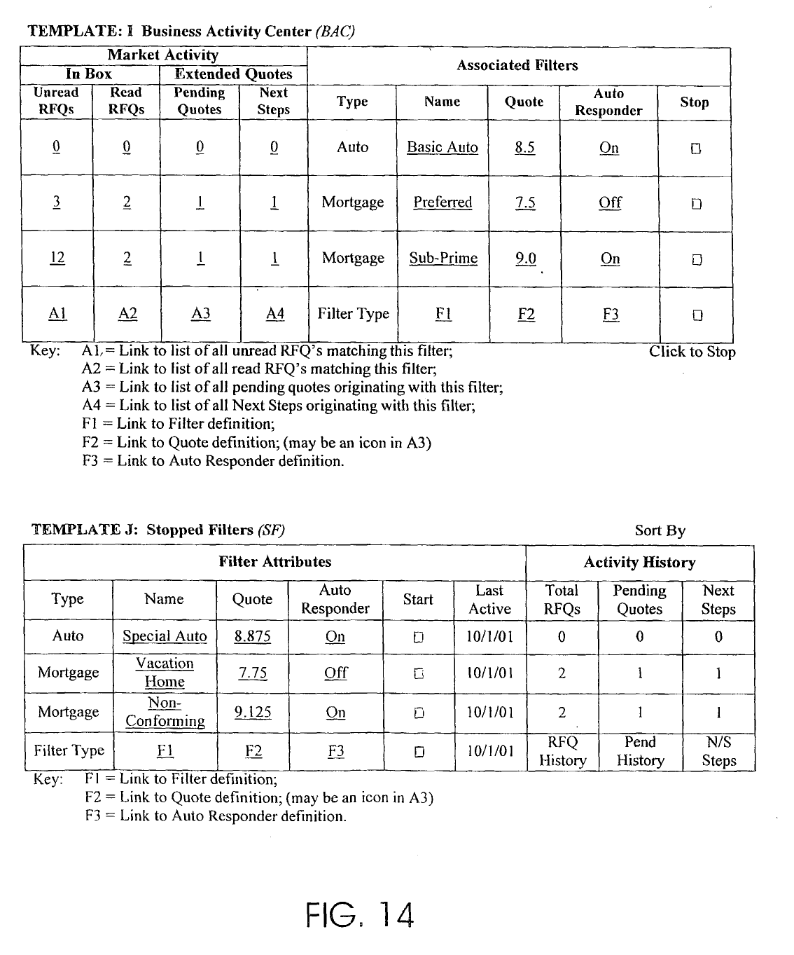

FIG. 12 shows the Lender site Map 900, which contains two main centers, a Control Center 910 and an Activity Center 950. The Control Center 910 includes the Lender's personal home page (PHP) 912 and Filter Tools 914-920. From the Lender's personal home page 912, the Lender may change personal settings, review their ratings by the Members, receive help, or change administrative and financial aspects of their account. On the personal home page 912, the Lender has access to a Business Activity Center (BAC) 950, which is illustrated in more detail with respect to FIG. 14. The Filter Tools include a tool to create a filter 914, a tool to edit a filter 916, a utility to copy, rename or delete a filter, and a tool to stop the activity of a filter 920.

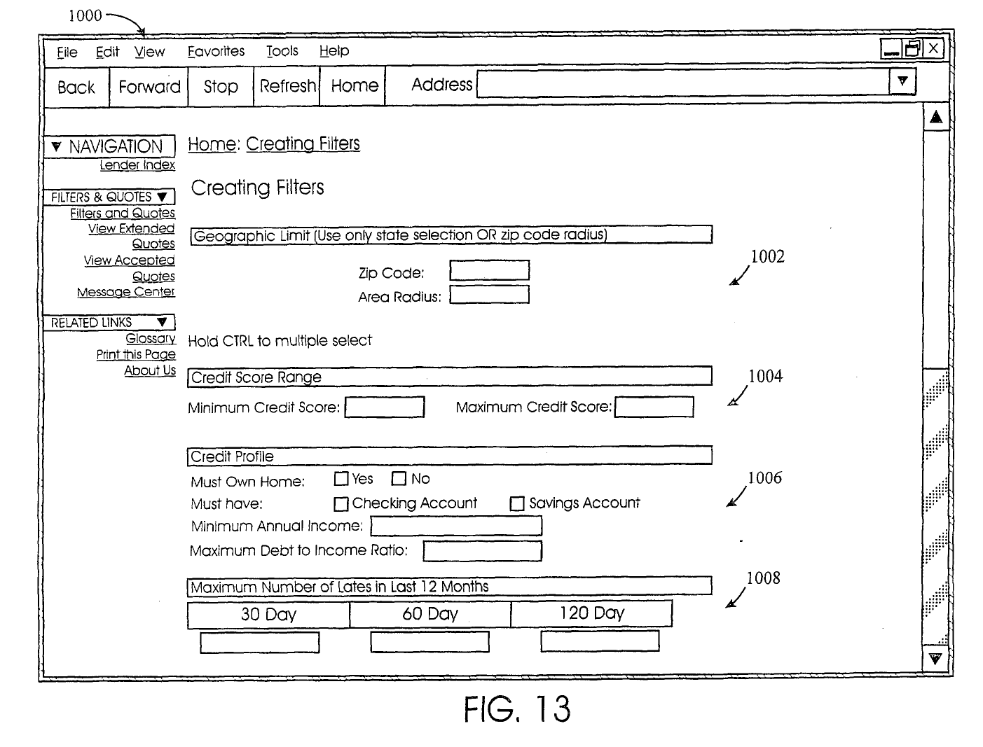

FIG. 13 shows an example web page 1000 provided by the Lender GUI 400 that allows a Lender to create filters for Member credit requests. The data fields include, for example, fields for limiting the geographic location of Member requests 1002, specifying a range of acceptable credit scores 1004, identifying desired elements of the Members financial profile 1006, and indicating a maximum number of late payments 1008 made in the past as a function of days. It is understood that additional fields may also be used to limit or specify the filter parameters, and that FIG. 13 is only exemplary in this respect.

FIG. 14 illustrates example screens that appear in the Lender interface 400. Template 1 illustrates an exemplary Business Activity Center (BAC) interface as described above. All unread and read requests for quotes, all pending quotes, and all accepted quotes, are provided in tabular format for each associated filter. The Lender may access detailed information by selecting linked items A1-A4 and F1-F3 in the table. For example, by selecting a number listed under the heading “Unread RFQ”, the lender is linked to a list of all unread requests for quotes matching the filter (e.g., linked item Al). The Lender may access more detail concerning the Filter definition, the quote definition, or an auto responder definition which automatically send a credit offer in the requisite filter conditions have been met. As shown in FIG. 14, the Lender may click to stop the filter from being used to process requests For credit.

Template J illustrates an exemplary Stopped Filters (SF) interface as described above. All the filters that the Lender has stopped using are listed in a table format. The Lender may access detailed information on the stopped filters by selecting linked items F1-F3 in the table. For example, by selecting a name of a filter listed in the table, the Lender is linked to a definition of the filter (Link F1). The Lender may select to start using the filter in processing requests for credit.

Returning briefly to FIG. 12, notice that the Activity Center 950 includes links for the Lender to process requests for credit, make offers of credit, or answer questions. In the activity center 950, the Lender may review accepted quotes in Next Steps 952. The Lender may review pending quotes 954 extended to Members, review unread requests for quotes 956 from Members, read requests for quotes 958 from Members, and review messages 960 received from Members.

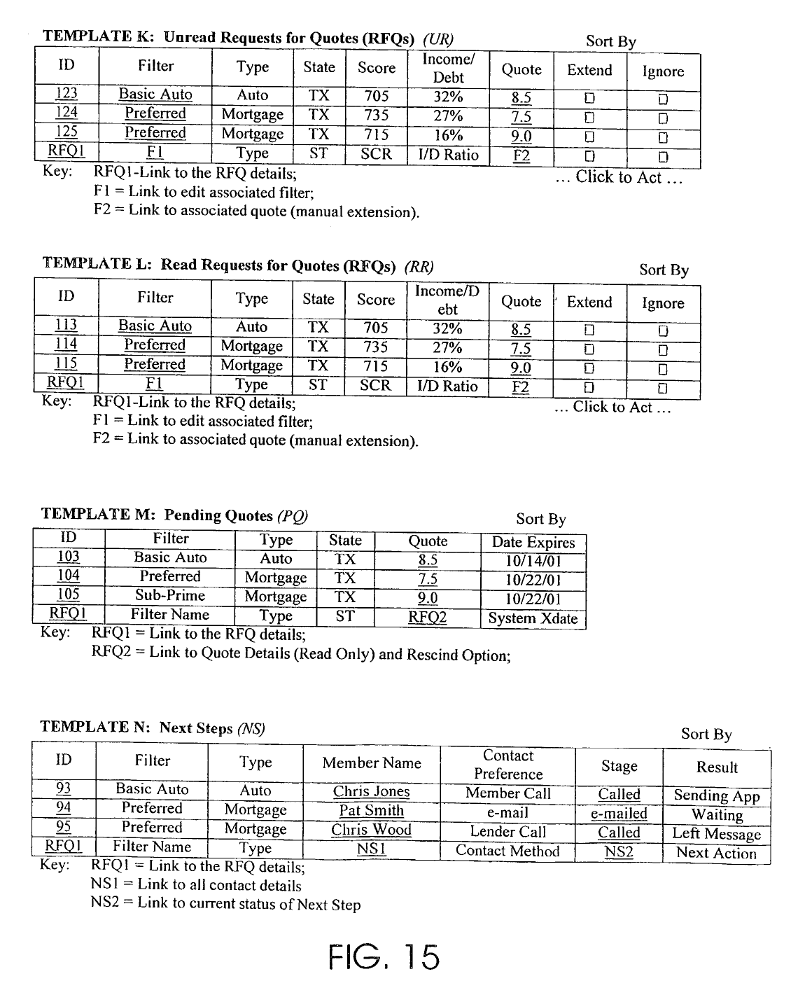

Referring to FIG. 15, templates K through N illustrate exemplary interfaces available to the Lender in the Activity Center as described above. Template K illustrates an example graphical user interface for the Unread Requests for Quotes (UR) as described above. All unread requests for quotes are given in table format. Each quote is given an ID number. Each unread request in listed with its filter name, type of request, Member's state, Member's credit score, the Member's debt to income ratio, and the quote amount associated with the Filer.

Template L illustrates a similar example graphical user interface for the Read Requests for Quotes (RR) as described above. In the tables for Templates K-L, the Lender may access detailed information by selecting linked items RFQI and F1-F2 in the table. For example, by selecting an ID number listed under the heading “ID”, the lender is linked to a detail of the request for credit (linked item RFQI). The lender may also select to extend a credit offer or ignore the request for credit appearing in the table.

Template M illustrates an exemplary interface for the Pending Quotes (PQ) that have not been answered (i.e., accepted) by Members as described above. In a preferred embodiment, the ID number for each pending quote can be linked to the ID number for the quote request. Each pending quote is listed with its filter name, type of request. Member's state, the quote, and the date the quote expires. In the table, the Lender may access detailed information by selecting linked items RFQ1 and RFQ2 in the table. For example, by selecting a quote amount for a pending quote in the table, the Lender is linked to a read-only detail of the quote with an option to rescind (linked item RFQ2).

Template N illustrates an exemplary Next Step (NS) that appears to the Lenders after a Member has accepted a credit offer. As before, each accepted quote is given the ID number of the request for the quote. Each pending quote is listed with its filter name, type of request, Member's name, the Member's contact preference, the current stage of the credit offer process, and the result of the current stage. In this table, the Lender may access detailed information by selecting linked items RFQ1, NS1 and NS2 in the table. For example, by selecting a Member's name in the table, the Lender is linked to contact details for the Member (linked item NSI).

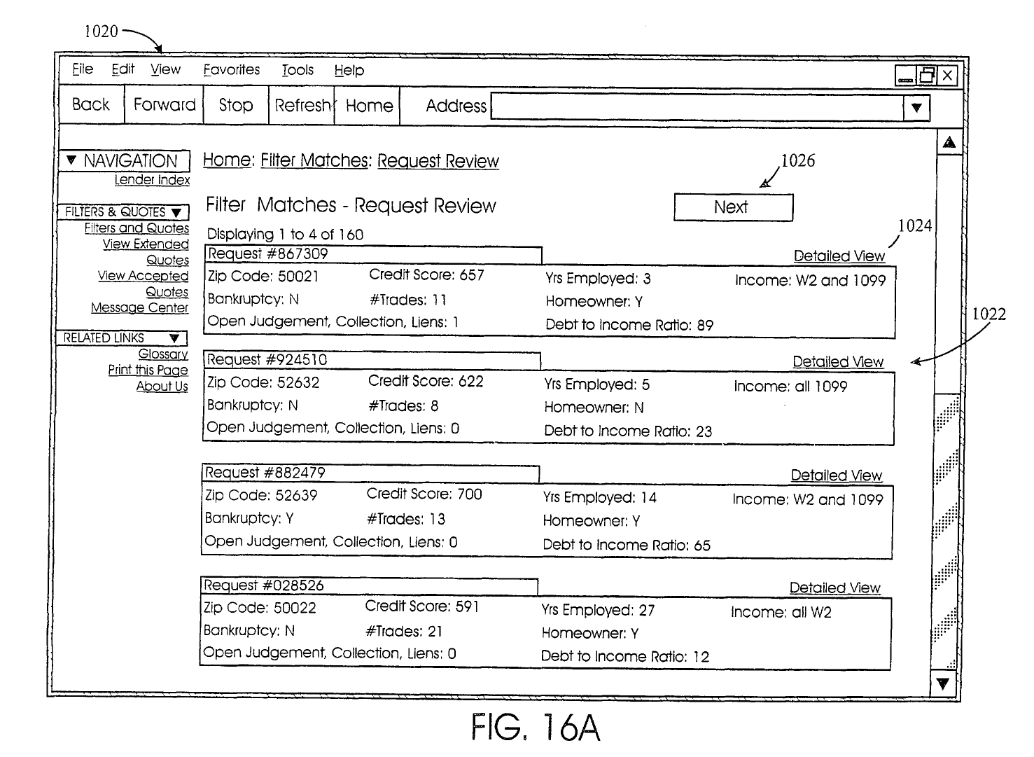

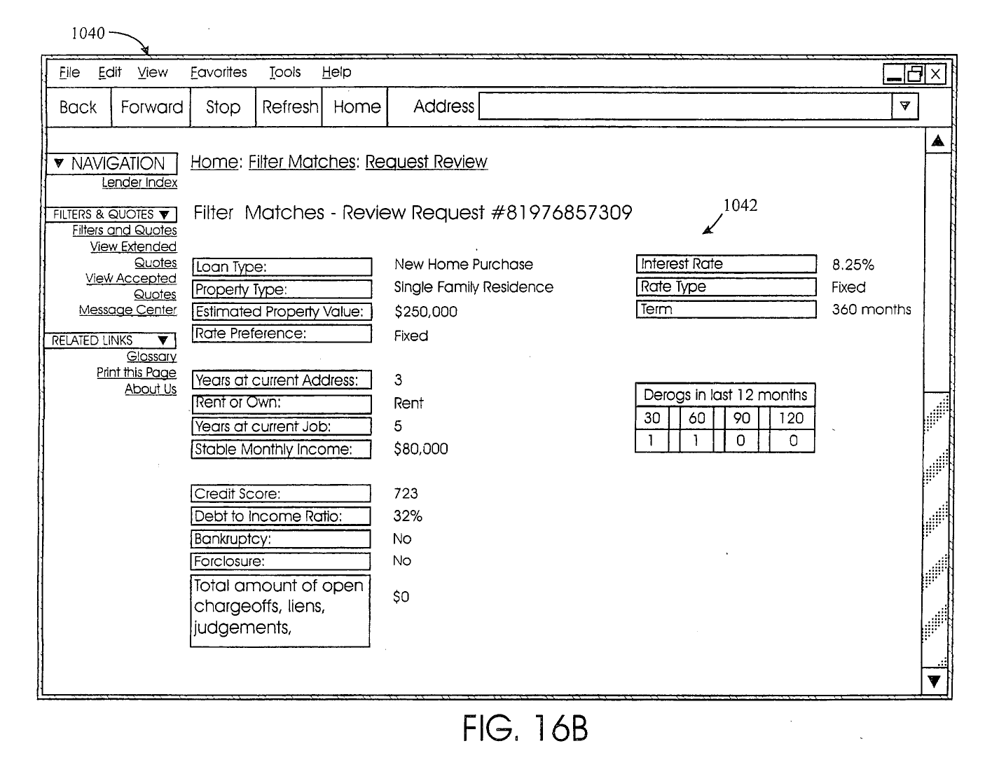

With the benefit of the present disclosure, it is understood that one skilled in the art of Internet Web design may readily construct web pages providing a graphical user interface for the Templates I-N described above. For example, an example web page 1020 in FIG. 16A illustrates abbreviated matches 1022 after filtering the credit requests of the Members.

From the web page 1020, the Lender may access details of a Member's credit profile and request by selecting a detailed view 1024 for a given abbreviated match 1022. For example, an example web page 1040 in FIG. 16B illustrates a detail 1042 of a Member's credit profile and request. The detail 1042 may contain more description of the request and credit profile of the Member. As noted previously, the request and profile are anonymous and do not contain personally identifying information on the Member. The request and profile is identified only by the request number.

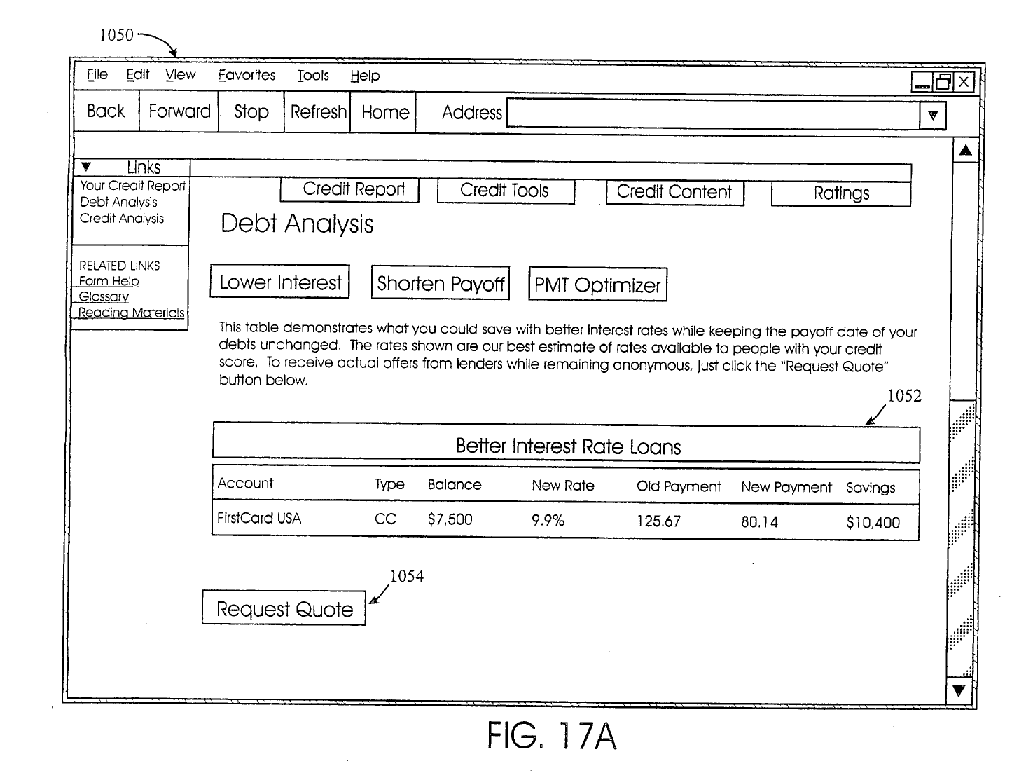

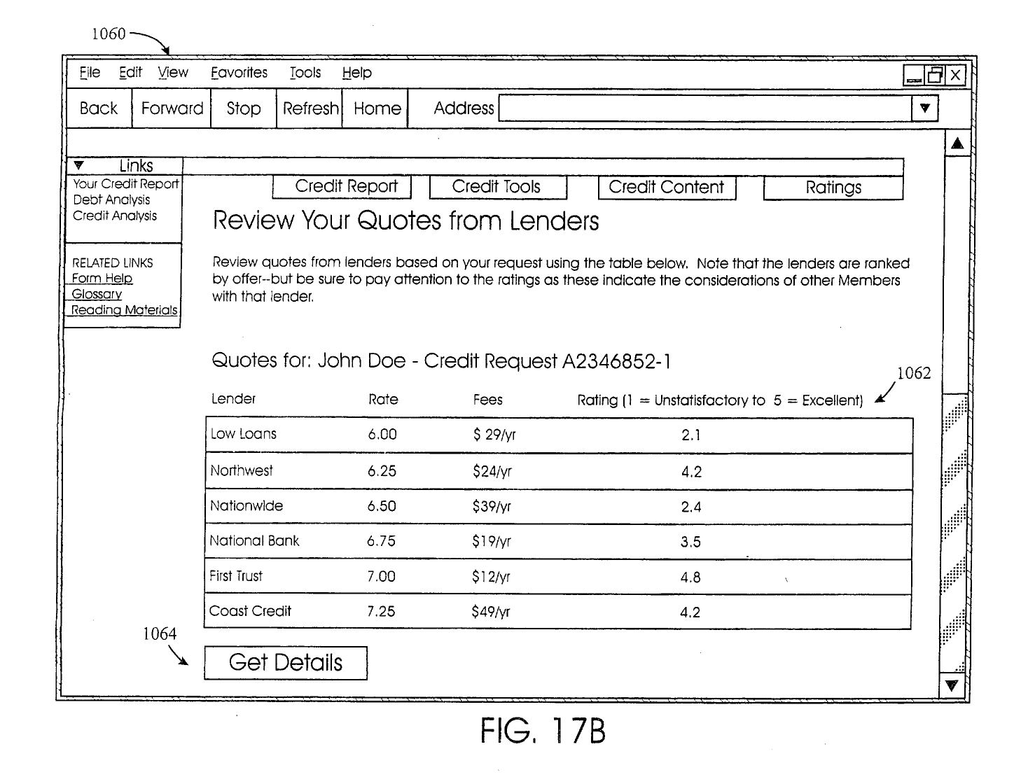

FIG. 17A shows an exemplary web page 1050, which allows a Member to compare one of their stored credit accounts with similar credit offered on better terms in the marketplace. Specifically, the exemplary web page 1050 may be part of the Learning Center 830 in FIG. 11. FIG. 17A shows that if the Member can locate a credit card with 9.9% interest, it would save a total of $10,400 over the life of the loan when compared with the Member's stored credit account as a reference. Using this information, the Member can shop for credit offered on these more favorable terms using Link 1054. Accordingly, the Member is linked to associated web pages for building a request for a quote as described above.

FIG. 17B shows an exemplary web page 1060, which allows a Member to review offers extended from various Lenders. The quotes include all of the details provided by the Lenders plus additional information and analysis provided by the system, such as the Lenders' customer satisfaction rating and the true APR (annual percentage rate) the lender is charging. In the table 1062, the Lenders submitting offers in response to the Member's credit request are listed by name. Each offer or quote is listed with a rate and fees. Furthermore, the rating of each Lender is listed. The Member may click a link 1064 on the web page 1060 to obtain further details about the offers.

While the invention has been described with reference to the preferred embodiments, obvious modifications and alterations are possible by those skilled in the related art. Therefore, it is intended that the invention include all such modifications and alterations to the full extent that they come within the scope of the following claims or the equivalents thereof.

1. A method for facilitating a transaction between a first party and at least one second party offering a good or service, the method implementable on a computer system, the method comprising:
a) receiving an electronic request by the first party for a quote relating to the good or service;
b) retrieving an electronic credit report for the first party;
c) electronically configuring the request and the credit report to create an identity for the first party, wherein configuring to create the identity comprises removing first party personal information from the request and the credit report; and
d) placing the identity on the system to make it accessible to the at least one second party.

2. The method of claim 1, further comprising receiving an electronic filter from the at least one second party to filter the request dependent on parameters specified in the identity.

3. The method of claim 1, further comprising receiving an electronic offer from the at least one second party in response to the request.

4. The method of claim 3, further comprising electronically charging at least one second party a transaction fee upon receipt of the offer.

5. The method of claim 3, further comprising receiving an electronic acceptance from the first party in response to the offer.

6. The method of claim 5, further comprising providing the first party personal information to the at least one second party.

7. A method for facilitating a transaction between one or more first parties and a second party offering a good or service, the method implementable on a computer system, the method comprising:
a) receiving electronic requests from the one or more first parties for quotes relating to the good or service, the requests containing parameters relevant to the good or service; and
b) receiving an electronic filter from the second party, wherein the filter specifies suitable request parameters;
c) electronically filtering the requests in accordance with the filter to select requests having the suitable request parameters; and
d) storing the filtered requests in a queue accessible only by the second party.

8. The method of claim 7, wherein the requests include electronically obtained credit information for the one or more first parties.

9. The method of claim 8, wherein the requests are configured to remove personal information concerning the one or more first parties.

10. The method of claim 7, further comprising receiving an electronic offer from the second party in response to the filtered request of one of the first parties.

11. The method of claim 10, further comprising electronically charging the second party a transaction fee upon receipt of the offer.

12. The method of claim 10, further comprising receiving an electronic acceptance from the one first party in response to the offer.

13. The method of claim 12, further comprising providing personal information concerning the one first party to the second party.

14. The method of claim 7, further comprising automatically receiving an electronic offer from the second party in response to the filtered requests in the queue.

15. A method for funding a computer system for facilitating a transaction between a first party and one or more second parties offering a good or service, the method implementable on a computer system, the method comprising:
a) electronically receiving a request by the first party for a quote relating to the good or service;
b) placing the request on the system to make it accessible to the one or more second parties;
c) electronically receiving one or more offers relating to the good or service from the one or more second parties in response to the request, the received offers being accessible by the first party who may accept the offers; and
d) electronically charging the one or more second parties a first transaction fee upon receipt of the offers.

16. The method of claim 15, wherein the request includes electronically obtained credit information for the first party.

17. The method of claim 16, wherein the request is configured to remove personal information concerning the first party.

18. The method of claim 15, further comprising receiving an electronic acceptance from the first party in response to one of the offers.

19. The method of claim 18, further comprising electronically charging one second party a second transaction fee upon receipt of the acceptance of the one offer, wherein the second transaction fee replaces the first transaction fee charged to the one second party.

20. The method of claim 19, further comprising providing first party personal information to the one second party.

21. The method of claim 15, further comprising receiving an electronic filter from the one or more second parties to filter the request dependent on parameters specified in the request.

22. The method of claim 15, wherein the first transaction fee is apportioned between all of the one or more second parties for which offers are received.

23. A system for facilitating a transaction between a first party and at least one second party offering a good or service, comprising:
a) a first database for receiving an electronic request by the first party for a quote relating to the good or service;
b) a second database for storing an electronic credit report for the first party;
c) a third database for storing an anonymous identity for the first party, wherein the identity comprises a combination of the request in the first database and the credit report in the second database; and
d) a fourth database for placing the identity on the system to make it accessible to the at least one second party.

24. A system for facilitating a transaction between a plurality of first parties and a second party offering a good or service, comprising:
a) a first database for receiving electronic requests by the first parties for quotes relating to the good or service, the first database also storing parameters specified by the first parties relevant to the good or service;
b) an electronic filter defined by the second party which specifies suitable request parameters; and
c) an electronic queue for storing the requests passed by the filter.

25. A system for facilitating a transaction between a first party and at least one second party offering a good or service, comprising:
a) a first database for receiving an electronic request by the first party for a quote relating to the good or service;
b) a second database for receiving an offer relating to the good or service from the at least one second party in response to the request, the received offer being accessible by the first party who may accept the offer; and
c) a third database containing fees charged to the at least one second party in response to the received offer.
